(19) United States
(12) Patent Application Publication
(10) Pub. No.: US 2009/0244200 A1
(43) Pub. Date: Oct. 1, 2009

(54) LIQUID DISCHARGING METHOD, LIQUID DISCHARGING HEAD, AND LIQUID DISCHARGING APPARATUS

(75) Inventor: Kinya OZAWA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/404,951

(22) Filed: Mar. 16, 2009

(30) Foreign Application Priority Data
Mar. 26, 2008 (JP) 2008-082180
Nov. 28, 2008 (JP) 2008-305335

(51) Int. Cl. B41J 2/045

(52) U.S. Cl. 347/68

(57) ABSTRACT

A liquid discharging method includes applying pressure to liquid and discharging the liquid from a liquid discharging head. The viscosity of the liquid ranges from 8 to 20 millipascal seconds. The liquid discharging head includes a nozzle that discharges the liquid, a pressure chamber that causes a pressure change in the liquid so as to discharge the liquid from the nozzle, and a liquid supplying section that is in communication with, and supplies the liquid to, the pressure chamber. The pattern of the pressure change in the liquid varies to selectively control the amount of the liquid discharged from the nozzle between a predetermined amount and another smaller amount. The diameter of the nozzle ranges from 15 μm to 40 μm. The flow-channel length of the nozzle is set at a value that is smaller than the flow-channel length of the liquid supplying section multiplied by 0.2.

### BACKGROUND

1. Technical Field

The present invention relates to a liquid discharging method, a liquid discharging head, and a liquid discharging apparatus.

2. Related Art

Some liquid discharging apparatuses such as an ink-jet printer and the like has nozzles from which liquid is discharged, pressure generation chambers that cause a pressure change to occur in liquid so as to discharge the liquid through the respective nozzles, and liquid supply passages through which liquid that is temporarily trapped in a reservoir is supplied to the respective pressure generation chambers. An example of such a liquid discharging apparatus is described in JP-A-2005-34998. The dimension of each liquid flow channel inside the liquid discharging head of such a liquid discharging apparatus is predetermined on the basis of the viscosity of a certain type of liquid that is close to the viscosity of water.

Recently, experiments have been undertaken for discharging liquid whose viscosity is higher than that of ordinary ink by utilizing an ink-jet technique. However, as revealed by these experiments, it has been difficult to stabilize the discharging of liquid if liquid that has high viscosity is discharged with the use of a head that has a related-art configuration. For example, it is found to be difficult to obtain a desired discharge movement trajectory such as straight one when liquid is discharged from a head of the related art. In addition, it is further found that the discharge amount of some liquid drops could be smaller than normal amount when liquid is discharged from a head of the related art.

### SUMMARY

An advantage of some aspects of the invention is to make it possible to discharge plural types of liquid drops that are different in amount from each other or one another in a stable manner, for example, with substantially reduced variation in the amount thereof, for a type of liquid whose viscosity is higher than that of ordinary liquid such as ordinary ink.

In order to offer the above features and advantages, a main aspect of the invention provides a liquid discharging method that includes: applying pressure to liquid that is to be discharged; and discharging the liquid from a liquid discharging head, wherein the viscosity of the liquid is within a range from 8 millipascal second inclusive to 20 millipascal second inclusive, wherein the liquid discharging head includes a nozzle from which the liquid is discharged, a pressure chamber that causes a pressure change in the liquid so as to discharge the liquid from the nozzle, and a liquid supplying section that is in communication with the pressure chamber and supplies the liquid to the pressure chamber, wherein the pattern of the pressure change that occurs in the liquid is varied so as to selectively switch or control the amount of the liquid that is discharged from the nozzle at least between a predetermined amount and another amount that is smaller than the predetermined amount; wherein the diameter of the nozzle is set within a range from 15 μm inclusive to 40 μm inclusive; and the flow-channel length of the nozzle is set at a value that is smaller than the flow-channel length of the liquid supplying section multiplied by 0.2.

Other features and advantages offered by the invention will be fully understood by referring to the following detailed description in conjunction with the accompanying drawings.

### BRIEF DESCRIPTION OF THE DRAWINGS

The invention will be described with reference to the accompanying drawings, wherein like numbers reference like elements.

FIG. 1 is a block diagram that schematically illustrates an example of the configuration of a printing system that includes a printer according to an exemplary embodiment of the invention.

FIGS. 2A and 2B are a set of diagrams that schematically illustrates an example of the configuration of a head according to an exemplary embodiment of the invention; specifically, FIG. 2A is a sectional view of the head, whereas FIG. 2B is a model perspective view that schematically illustrates an example of the structure of the head.

FIG. 3 is a block diagram that schematically illustrates an example of the configuration of a driving signal generation circuit, a head control unit, and the head according to an exemplary embodiment of the invention.

FIG. 4 is a diagram that schematically illustrates an example of the signal waveform of a driving signal according to an exemplary embodiment of the invention.

FIGS. 5A and 5B are a set of diagrams each of which schematically illustrates an example of the pulse pattern of a discharging pulse according to an exemplary embodiment of the invention; specifically, FIG. 5A is a diagram that schematically illustrates an example of the pulse pattern of a discharging pulse for the formation of a large dot, whereas FIG. 5B is a diagram that schematically illustrates an example of the pulse pattern of a discharging pulse for the formation of a small dot.

FIGS. 6A and 6B are a set of diagrams each of which schematically illustrates an example of the discharging of high viscosity ink; specifically, FIG. 6A is a diagram that schematically illustrates an example of a stable discharging state in which high viscosity ink is discharged with ink-drop discharging uniformity, whereas FIG. 6B is a diagram that schematically illustrates an example of an unstable discharging state in which high viscosity ink is discharged without ink-drop discharging uniformity.

FIG. 7 is a diagram that shows the property of evaluation target heads according to an exemplary embodiment of the invention and the property of evaluation target heads of comparative examples.

FIG. 8 is a diagram that shows the dimension of evaluation target heads HD according to an exemplary embodiment of the invention and the dimension of evaluation target heads of comparative examples.

FIG. 9 is a diagram that schematically illustrates an example of the evaluation result of the discharging of ink drops for the formation of large dots that is performed by a head according to a first example of an exemplary embodiment of the invention.

FIG. 10 is a diagram that schematically illustrates an example of the evaluation result of the discharging of ink drops for the formation of small dots that is performed by a head according to the first example of an exemplary embodiment of the invention.

FIG. 11 is a diagram that schematically illustrates an example of the evaluation result of the discharging of ink drops for the formation of large dots that is performed by a head according to a second example of an exemplary embodiment of the invention.

FIG. 12 is a diagram that schematically illustrates an example of the evaluation result of the discharging of ink drops for the formation of small dots that is performed by a head according to the second example of an exemplary embodiment of the invention.

FIG. 13 is a diagram that schematically illustrates an example of the evaluation result of the discharging of ink drops for the formation of large dots that is performed by a head according to a third example of an exemplary embodiment of the invention.

FIG. 14 is a diagram that schematically illustrates an example of the evaluation result of the discharging of ink drops that is performed by a head according to a first comparative example NG1.

FIG. 15 is a diagram that schematically illustrates an example of the evaluation result of the discharging of ink drops that is performed by a head according to a second comparative example NG2.

FIG. 16 is a diagram that schematically illustrates an example of the evaluation result of the discharging of ink drops that is performed by a head according to a third comparative example NG3.

FIG. 17 is a diagram that schematically illustrates an example of the evaluation result of the discharging of ink drops that is performed by a head according to a fourth comparative example NG4.

FIG. 18 is a sectional view that schematically illustrates an example of the configuration of a head according to a modified embodiment of the invention.

FIGS. 19A, 19B, and 19C are a set of diagrams that schematically illustrates an example of flow-channel components according to a modified embodiment of the invention; specifically, FIG. 19A shows an example of the structure of a nozzle that has a shape that resembles a funnel; FIG. 19B shows an example of an analysis model of the funnel-shaped nozzle; FIG. 19C shows an ink supply passage and a pressure generation chamber according to a modified embodiment of the invention.

### DESCRIPTION OF EXEMPLARY EMBODIMENTS

Referring to the following detailed description in conjunction with the accompanying drawings, one will fully understand at least the following inventive concept of the invention.

That is, a liquid discharging method that includes: applying pressure to liquid that is to be discharged; and discharging the liquid from a liquid discharging head, wherein the viscosity of the liquid is within a range from 8 millipascal second inclusive to 20 millipascal second inclusive, wherein the liquid discharging head includes a nozzle from which the liquid is discharged, a pressure chamber that causes a pressure change in the liquid so as to discharge the liquid from the nozzle, and a liquid supplying section that is in communication with the pressure chamber and supplies the liquid to the pressure chamber, wherein the pattern of the pressure change that occurs in the liquid is varied so as to selectively switch or control the amount of the liquid that is discharged from the nozzle at least between a predetermined amount and another amount that is smaller than the predetermined amount; wherein the diameter of the nozzle is set within a range from 15 μm inclusive to 40 μm inclusive; and the flow-channel length of the nozzle is set at a value that is smaller than the flow-channel length of the liquid supplying section multiplied by 0.2 is disclosed in detail as an exemplary embodiment in the following detailed description and the accompanying drawings. In a liquid discharging method that has features and operation elements explained above, the diameter of the nozzle opening is determined at such a value that is suitable for discharging plural types of ink drops that are different in amount from each other or one another in a selective manner. In addition, in a liquid discharging method that has features and operation elements explained above, the ratio of the flow-channel length of the nozzle to the flow-channel length of the liquid supplying section is set at an appropriate value that makes it possible to efficiently utilize a pressure change that occurs in liquid that is retained in the pressure chamber for the discharging thereof. As a result, it is possible to discharge plural types of liquid drops that are different in amount from each other or one another in a stable manner for a type of liquid whose viscosity is higher than that of ordinary liquid, that is, liquid having ordinary viscosity.

In a liquid discharging method that has features and operation elements explained above, it is preferable that the flow-channel length of the nozzle should be greater than or, at the shortest, equal to 30 μm. Such a preferred liquid discharging method makes it possible to secure required nozzle rigidity.

In a preferred liquid discharging method described above, it is further preferable that the flow-channel length of the liquid supplying section should be set within a range from 153 μm inclusive to 420 μm inclusive. Such a preferred liquid discharging method makes it possible to obtain the liquid-drop discharging amount of approximately 10 ng or greater for one type of a liquid drop that is larger in amount than the other.

In a liquid discharging method that has features and operation elements explained above, it is preferable that the flow-channel resistance of the liquid supplying section should be set at a value that is larger than the flow-channel resistance of the nozzle multiplied by 0.2. Such a preferred liquid discharging method makes it possible to discharge a liquid drop in a more stable manner.

In a liquid discharging method that has features and operation elements explained above, it is preferable that the inertance of the nozzle should be set at a value that is smaller than that of the liquid supplying section. Such a preferred liquid discharging method makes it possible to discharge liquid efficiently on the basis of a change in pressure that is applied to the liquid.

In a liquid discharging method that has features and operation elements explained above, it is preferable that the pressure chamber should include a demarcating section that demarcates a part of the pressure chamber and, when deformed, causes a pressure change in the liquid. Such a preferred liquid discharging method makes it possible to cause a change in pressure that is applied to the liquid retained in the pressure chamber efficiently.

In a preferred liquid discharging method described above, it is further preferable that the liquid discharging head should further include an element that causes the demarcating section to be deformed by a variable degree that depends on the pattern of a change in the potential of the discharging pulse that is applied to the element. Such a preferred liquid discharging method makes it possible to control the pressure of the liquid that is contained inside the pressure chamber with high precision.

In addition to the liquid discharging method including its preferred modes described above, it is understood that a liquid discharging head that has the following features and constituent elements is explained in detail as an exemplary embodiment in the following detailed description and the accompanying drawings. That is, a liquid discharging head that includes: a nozzle from which liquid is discharged; a pressure chamber that causes a pressure change in the liquid so as to discharge the liquid from the nozzle; and a liquid supplying section that is in communication with the pressure chamber and supplies the liquid to the pressure chamber, wherein the pattern of the pressure change that occurs in the liquid is varied so as to selectively switch or control the amount of the liquid that is discharged from the nozzle at least between a predetermined amount and another amount that is smaller than the predetermined amount; the diameter of the nozzle is set within a range from 15 μm inclusive to 40 μm inclusive; and the flow-channel length of the nozzle is set at a value that is smaller than the flow-channel length of the liquid supplying section multiplied by 0.2 is disclosed in detail as an exemplary embodiment in the following detailed description and the accompanying drawings.

In addition to the liquid discharging method and the liquid discharging head including its preferred modes described above, it is understood that a liquid discharging apparatus that has the following features and constituent elements is explained in detail as an exemplary embodiment in the following detailed description and the accompanying drawings. That is, a liquid discharging apparatus that includes: a discharging pulse generating section that generates a discharging pulse; and a liquid discharging head that discharges liquid from a nozzle, the liquid discharging head including a pressure chamber that causes a pressure change in the liquid by utilizing the deformation of a demarcating section so as to discharge the liquid from the nozzle, the pressure chamber varying the pattern of the pressure change that occurs in the liquid so as to selectively switch or control the amount of the liquid that is discharged from the nozzle at least between a predetermined amount and another amount that is smaller than the predetermined amount, an element that causes the demarcating section to be deformed by a variable degree that depends on the pattern of a change in the potential of the discharging pulse that is applied to the element, and a liquid supplying section that is in communication with the pressure chamber and supplies the liquid to the pressure chamber, wherein the diameter of the nozzle is set within a range from 15 μm inclusive to 40 μm inclusive; and the flow-channel length of the nozzle is set at a value that is smaller than the flow-channel length of the liquid supplying section multiplied by 0.2 is disclosed in detail as an exemplary embodiment in the following detailed description and the accompanying drawings.

### First Embodiment

### Printing System

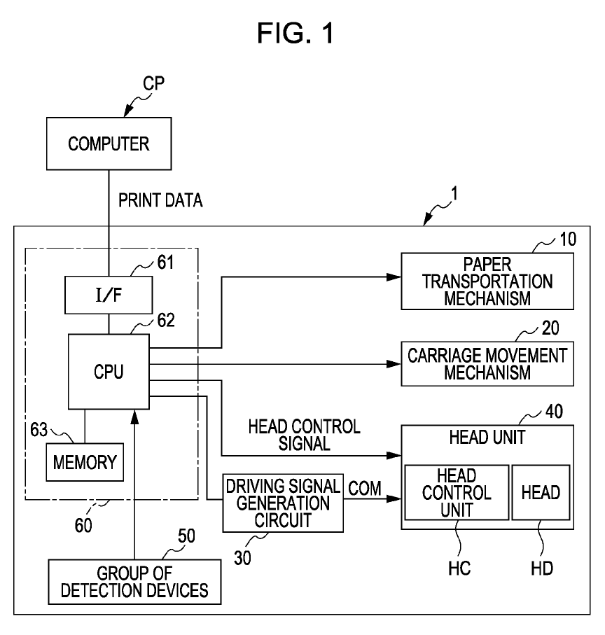

A printing system illustrated in FIG. 1 includes a printer 1 and a computer CP. The printer 1 discharges ink, which is an example of various kinds of liquid, onto various kinds of discharging target media such as a sheet of paper, cloth, film, or the like. The printer 1 described herein is an example of a liquid discharging apparatus according to an aspect of the invention. The medium is a liquid discharge target object onto which liquid is discharged. The computer CP is connected to the printer 1 so that communication can be performed therebetween. The computer CP transmits print data corresponding to a print-instructed image to the printer 1 when the computer CP causes the printer 1 to perform the printing thereof.

### Overall Configuration of Printer 1

The printer 1 includes a paper transportation mechanism 10, a carriage movement mechanism 20, a driving signal generation circuit 30, a head unit 40, a group of detection devices 50, and a printer-side controller 60.

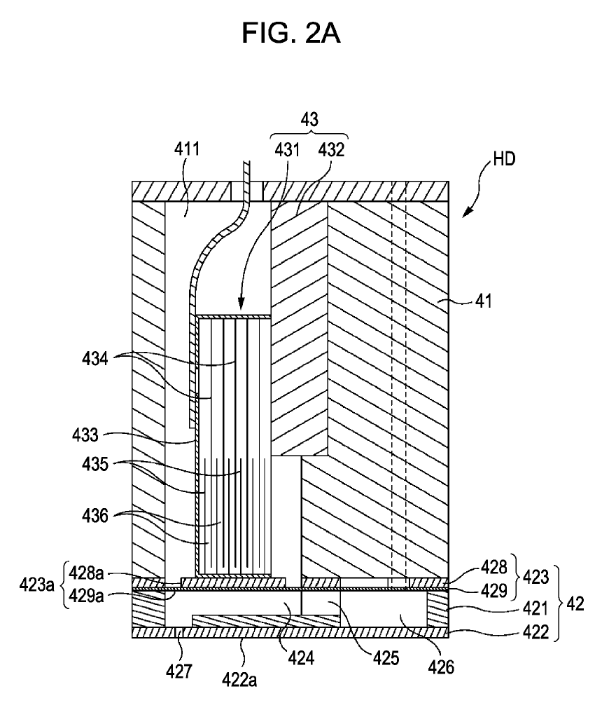

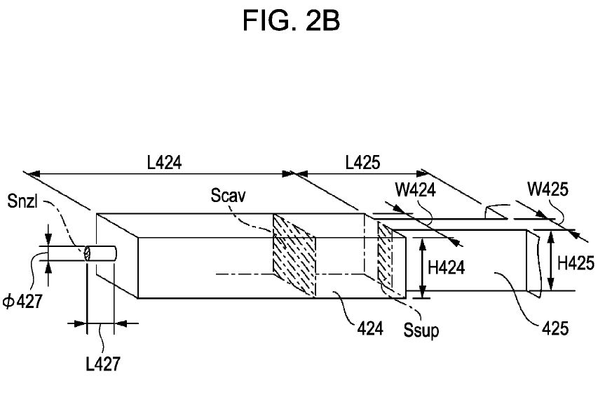

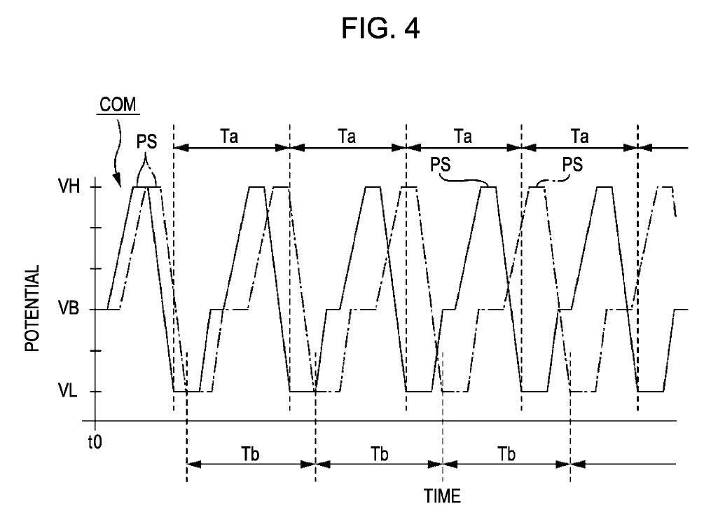

The paper transportation mechanism 10 transports a sheet of printing paper in a paper transport direction. The carriage movement mechanism 20 moves a carriage on which the head unit 40 is mounted in a predetermined movement direction (for example, a paper width direction). The driving signal generation circuit 30 generates a driving signal COM. The driving signal COM is applied to a head HD (piezoelectric elements 433, refer to FIG. 2A) when printing is performed on a sheet of printing paper. As illustrated in FIG. 4 as an example thereof, the driving signal COM is a pulse signal that includes discharging pulses PS. Herein, the discharging pulse PS is used for causing the piezoelectric elements 433 to perform predetermined operation so that the head HD discharges ink drops. It is possible to adjust the amount of ink drops that are discharged from the head HD (nozzles 427) by varying the pattern of the voltage change of the discharging pulse PS. Since the driving signal COM includes the discharging pulses PS, the driving signal generation circuit 30 described herein is an example of a discharging pulse generating section according to an aspect of the invention. The configuration of the driving signal generation circuit 30 will be explained later. A more detailed explanation of the discharging pulses PS will also be given later. The head unit 40 includes the head HC and a head control unit HC. The head HD discharges ink onto a sheet of printing paper. The head control unit HC controls the operation of the head HD on the basis of a head control signal that is supplied from the printer-side controller 60. The configuration of the head HD will be explained later. The group of detection devices 50 is made up of a plurality of detectors that monitors the operation state of the printer 1. The result of detection performed by the plurality of detectors is outputted to the printer-side controller 60. The printer-side controller 60 controls the entire operation of the printer 1. The printer-side controller 60 will also be explained later.

### Main Components of Printer 1

### Head HD

As illustrated in FIG. 2A, the head HD is provided with a case 41, a fluid channel unit 42, and a piezoelectric element unit 43. The case 41 is a member that has an inner housing cavity 411. The piezoelectric element unit 43 is housed in, and fixed to, the housing cavity 411 that is formed inside the case 41. The case 41 is made of, for example, a resin material. The fluid channel unit 42 is bonded or attached by other means to the front-end plane of the case 41.

The fluid channel unit 42 is provided with a fluid channel formation substrate 421, a nozzle plate 422, and a vibration plate 423. The nozzle plate 422 is bonded or attached by other means to one surface of the fluid channel formation substrate 421. The vibration plate 423 is bonded or attached by other means to the other surface of the fluid channel formation substrate 421. Gutter parts that constitute a plurality of pressure generation chambers 424, gutter parts that constitute a plurality of ink supply passages 425, and an opening part that constitutes a common ink chamber 426 are formed in the fluid channel formation substrate 421. Herein, the term “chamber” encompasses the meaning of “compartment” and “cavity” without any limitation thereto. Accordingly, the alternative term mentioned above may be used in place of the chamber in the following description of this specification. The fluid channel formation substrate 421 is made of, for example, a silicon substrate. Each of the plurality of pressure generation chambers 424 is formed as a long and narrow compartment that is elongated in the direction orthogonal to the direction of the array of the plurality of nozzles 427. The ink supply passage 425 is formed between the pressure generation chamber 424 and the common ink chamber 426 so as to make the common ink chamber 426 in communication with the pressure generation chamber 424. As an example of various kinds of liquid, ink is temporarily trapped in the common ink chamber 426, which functions as an ink reservoir. The ink retained in the common ink chamber 426 flows through the ink supply passage 425 and then is supplied to the pressure generation chamber 424. Therefore, the ink supply passage 425 described herein is an example of a liquid supplying section according to an aspect of the invention, which functions as, for example, a liquid supply flow path through which liquid is supplied to the pressure generation chamber 424. The common ink compartment 426 described herein, which temporarily traps ink that has been supplied from ink cartridges that are not shown in the drawing, is an example of a common liquid reservoir according to an aspect of the invention.

The plurality of nozzles 427 is formed through the nozzle plate 422. In a plan view, the plurality of nozzles 427 is arrayed in a predetermined direction at predetermined intervals. Ink is discharged out of the head HD through these nozzles 427. The nozzle plate 422 is made of, for example, a stainless plate, a silicon substrate, and the like.

The vibration plate 423 has a dual layer structure. For example, an elastic membrane 429 that is made of resin is laminated on the surface of a supporting plate 428 that is made of stainless. At the area part of the vibration plate 423 corresponding to each of the plurality of pressure generation chambers 424, the supporting plate 428 is locally etched away in a ring-shaped pattern. An island part 428a is formed inside the ring as an isolated part. The island part 428a of the supporting plate 428 and a peripheral area part 429a of the elastic membrane 429, the latter of which is an area part around the island part 428a when viewed in plan, make up each diaphragm part 423a of the vibration plate 423. The diaphragm part 423a becomes deformed due to the operation of the piezoelectric element 433 of the piezoelectric element unit 43. When the diaphragm part 423a becomes deformed, the capacity of the pressure generation chamber 424 changes. That is, the diaphragm part 423a of the vibration plate 423 described herein is an example of a demarcating section according to an aspect of the invention, which constitutes, for example, a part of the chamber wall of the pressure generation chamber 424 and, when deformed, causes a pressure change in ink (liquid) that is retained in the pressure generation chamber 424.

The piezoelectric element unit 43 includes a cluster of piezoelectric elements 431 and a fixation plate 432. The cluster of piezoelectric elements 431 is arrayed in the shape of comb teeth. Each tooth of the comb teeth corresponds to the piezoelectric element 433. The front-end surface of each of the plurality of piezoelectric elements 433 is bonded or attached by other means to the corresponding one of the island parts 428a of the supporting plate 428. The fixation plate 432 functions both as a plate that supports the cluster of piezoelectric elements 431 and a plate that is fixed to the case 41. The fixation plate 432 is made of a stainless plate or the like. The fixation plate 432 is bonded or attached by other means to the inner-wall surface of the housing cavity 411.

The piezoelectric element 433 is a kind of an electromechanical transducer, that is, an electromechanical conversion element. Specifically, the piezoelectric element 433 is a device that performs deformation operation so as to cause a pressure change in liquid that is retained in the pressure generation chamber 424. The piezoelectric element 433 illustrated in FIG. 2A expands/contracts along the direction of the length of the element body thereof, which is orthogonal to the lamination direction, in accordance with a difference in the levels of electric potentials (i.e., voltage) that are applied to electrodes arrayed adjacent to one another. The electrodes mentioned above include a common electrode 434 and a driving electrode 435. The electric potential of the common electrode 434 is set at a predetermined level, whereas the electric potential of the driving electrode 435 takes a value that depends on the driving signal COM (i.e., discharging pulse PS). A piezoelectric substance (e.g., piezoelectric crystal, though not limited thereto) 436, which is sandwiched between the common electrode 434 and the driving electrode 435, becomes deformed in accordance with a difference between the electric-potential level of the common electrode 434 and the electric-potential level of the driving electrode 435. The piezoelectric element 433 expands or contracts in the direction of the length of the element body thereof when the piezoelectric substance 436 becomes deformed. In the configuration of the printer 1 according to the present embodiment of the invention, the electric potential of the common electrode 434 is set at either a ground electric-potential level or a bias electric-potential level that is higher than the ground electric-potential level by a predetermined value. The piezoelectric element 433 contracts when the electric-potential level of the driving electrode 435 increases relative to the electric-potential level of the common electrode 434, where the degree of contraction depends on the relationship between the electric-potential level of the driving electrode 435 and the electric-potential level of the common electrode 434. On the contrary, the piezoelectric element 433 expands when the electric-potential level of the driving electrode 435 decreases relative to the electric-potential level of the common electrode 434. As the electric-potential level of the driving electrode 435 approaches the electric-potential level of the common electrode 434, the piezoelectric element 433 expands. Or, the degree of the expansion of the piezoelectric element 433 becomes greater as the electric-potential level difference between the driving electrode 435 and the common electrode 434 becomes greater when the electric-potential level of the driving electrode 435 is lower than the electric-potential level of the common electrode 434.

As has been explained above, the piezoelectric element unit 43 is indirectly mounted on the case 41 with the fixation plate 432 being fixed therebetween. Because of such a structure, the diaphragm part 423a of the vibration plate 423 is pulled away from the pressure generation chamber 424 when the piezoelectric element 433 contracts. As a result, the capacity of the pressure generation chamber increases. On the contrary, the diaphragm part 423a of the vibration plate 423 is pushed toward the pressure generation chamber 424 when the piezoelectric element 433 expands. As a result, the capacity of the pressure generation chamber 424 decreases. A pressure change occurs in ink that is retained in the pressure generation chamber due to the expansion/contraction of the pressure generation chamber 424. Specifically, the ink that is retained in the pressure generation chamber 424 is pressurized due to the contraction of the pressure generation chamber 424, whereas the ink that is retained in the pressure generation chamber 424 is depressurized due to the expansion of the pressure generation chamber 424. Since the expansion/contraction state of the piezoelectric element is determined depending on the electric-potential level of the driving electrode 435, the capacity of the pressure generation chamber 424 is also determined depending on the electric-potential level of the driving electrode 435. For this reason, it can be said that the piezoelectric element is an element that deforms the diaphragm part 423a (demarcating section) of the vibration plate 423 by a variable degree depending on the pattern of the voltage change (i.e., electric potential change) of a discharging pulse PS applied thereto. Herein, it is possible to set the degree of pressurization/depressurization of the ink that is retained in the pressure generation chamber 424 on the basis of, for example, the amount of a change in the electric-potential level of the driving electrode 435 per unit time.

### Ink Flow Channel

Ink flow channels whose number is the same as the number of the nozzles 427 are formed in the head HD. Each of the plurality of the ink flow channels is formed as a passage through which ink flows from the common ink chamber 426 to the corresponding nozzle 427. The ink flow channel described herein corresponds to a liquid flow channel that is filled with liquid. In the structure of such an ink flow channel, the nozzle 427 is in communication with the pressure generation chamber 424 at one end of the pressure generation chamber 424. The ink supply passage 425 is in communication with the pressure generation chamber 424 at the other end thereof. The nozzle 427 has a relatively small flow channel in terms of flow channel area size in comparison with the flow channel of the pressure generation chamber 424. The ink supply passage 425 also has a relatively small flow channel in terms of flow channel area size in comparison with the flow channel of the pressure generation chamber 424. Since the components of the ink flow channel have such thickness relationships, it is possible to apply the concept of Helmholtz resonator to the ink flow channel described herein when analyzing the characteristics thereof such as ink-flow characteristics and the like.

FIG. 2B is a diagram that schematically illustrates an example of the configuration of an ink flow channel that is modeled on the basis of the concept mentioned above. Note that the illustrated ink flow channel has a shape that differs from an actual shape thereof. In the structure of the illustrated ink flow channel under the concept model, the pressure generation chamber 424 has the shape of a rectangular parallelepiped. The width of the pressure generation chamber 424 is denoted as W424. The height of the pressure generation chamber 424 is denoted as H424. The length of the pressure generation chamber 424 is denoted as L424. That is, the pressure generation chamber (i.e., cavity) 424 constitutes a flow channel that has a rectangular cross section Scav with a uniform section area. The ink supply passage 425 also has the shape of a rectangular parallelepiped. The width, height, and the length of the ink supply passage 425 are denoted as W425, H425, and L425, respectively. That is, the ink supply passage 425 constitutes a flow channel that has a rectangular cross section Ssup with a uniform section area. On the other hand, the nozzle 427 has the shape of a column. The diameter of the nozzle 427 is denoted as φ427. The length of the nozzle 427 is denoted as L427. That is, the nozzle 427 constitutes a flow channel that has a circular cross section Snzl with a uniform section area. The width W425 of the ink supply passage 425 is determined at a value that is not larger than the width W424 of the pressure generation chamber 424. The height H425 of the ink supply passage 425 is determined at a value that is not larger than the height W424 of the pressure generation chamber 424. If either one of the width W425 and the height H425 of the ink supply passage 425 is determined at the same value as the width/height W424, H424 of the pressure generation chamber 424, the other one of the width W425 and the height H425 of the ink supply passage 425 is determined at a value that is smaller than that (W424, H424) of the pressure generation chamber 424. That is, at least either one of the width W425 and the height H425 of the ink supply passage 425 is determined at a value that is smaller than that of the pressure generation chamber 424.

In the operation of the ink flow channel having the model structure explained above, ink is discharged from the nozzle 427 as a result of the occurrence of a change in the pressure of ink that is retained in the pressure generation chamber 424. In such operation, the pressure generation chamber 424, the ink supply passage 425, and the nozzle 427 behave as a Helmholtz resonator. For this reason, at the time when the ink that is retained in the pressure generation chamber 424 is pressurized, the pressure thereof changes at a unique cycle that is called as Helmholtz frequency. That is, pressure oscillation occurs in the ink.

Herein, the Helmholtz frequency (the natural vibration frequency or the eigenfrequency of ink), which is denoted as Tc, can be mathematically expressed by the following formula (1).

Tc=1/f

f=1/2π√[(Mn+Ms)/(Mn×Ms×(Cc+Ci))] (1)

In the above formula (1), Mn denotes the inertance of the nozzle 427, which is the mass of ink per unit cross-sectional area. A more detailed explanation thereof will be given later. The inertance of the ink supply passage 425 is denoted as Ms in the above formula (1). The compliance of the pressure generation chamber 424, which indicates a change in capacity per unit pressure, that is, the degree of softness, is denoted as Cc therein. The compliance of ink is denoted as Ci therein (where Ci=Volume V/[Density p×sonic velocity c²]). The amplitude of pressure oscillation decreases gradually as ink flows through the ink flow channel. For example, pressure oscillation attenuates due to loss in the nozzle 427 and the ink supply passage 425 as well as loss at, for example, the demarcation wall of the pressure generation chamber 424.

The Helmholtz frequency in the pressure generation chamber 424 in a typical configuration of the head HD falls within a range of 5 μs to 10 μs. The Helmholtz frequency varies depending on other factors such as the thickness of a wall part that demarcates one pressure generation chamber 424 from another pressure generation chamber 424 that is formed adjacent to the one pressure generation chamber 424 mentioned above, the thickness of the elastic membrane 429 and the compliance thereof, the material of the fluid channel formation substrate 421, the material of the nozzle plate 422, and the like.

### Printer-Side Controller 60

The printer-side controller 60 controls the entire operation of the printer 1. For example, on the basis of print data that has been sent from the computer CP and the result of detection that has been performed by each detector, the printer-side controller 60 controls the control target block/component for the printing of an image on a sheet of printing paper. As illustrated in FIG. 1, the printer-side controller 60 is provided with an interface unit 61, a CPU 62, and a memory 63. The interface unit 61 functions as an interface when the printer-side controller 60 receives data from the computer CP and when the printer-side controller 60 sends data to the computer CP. The CPU 62 controls the entire operation of the printer 1. The memory 63 provides a memory area for storing a computer program, a work area, and the like. The CPU 62 controls each of the control target blocks/components of the printer 1 in accordance with the computer program that is memorized in the memory 63. For example, the CPU 62 controls the operation of the paper transportation mechanism 10 and the carriage movement mechanism 20. In addition, the CPU 62 sends a head control signal to the head control unit HC so as to control the operation of the head HD. Moreover, the CPU 62 sends, to the driving signal generation circuit 30, a control signal so as to command the driving signal generation circuit 30 to generate a driving signal COM. In the description of this specification, the control signal that is sent from the CPU 62 to the driving signal generation circuit 30 for the generation of a driving signal COM may be referred to as DAC data. For example, the DAC data is digital data that is made up of a plurality of bits. The DAC data determines the pattern of the voltage change of a driving signal COM that is to be generated by the driving signal generation circuit 30. Therefore, it can be said that the DAC data is data that indicates the electric potential level of a discharging pulse PS and thus of a driving signal COM. The DAC data is pre-memorized in a predetermined area of the memory 63. The stored DAC data is read out at the time of issuing an instruction for the generation of a driving signal COM. The CPU 62 sends the read DAC data to the driving signal generation circuit 30.

### Driving Signal Generation Circuit 30

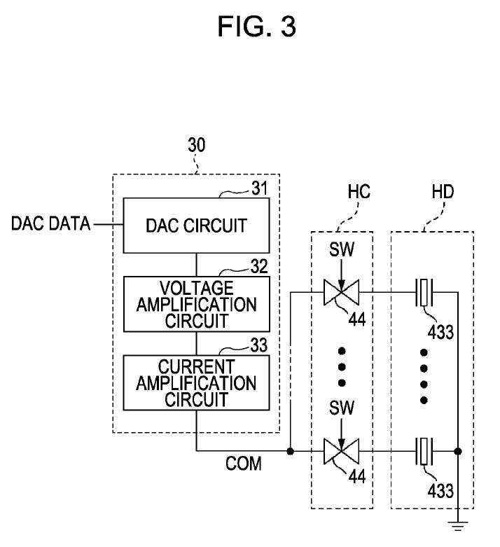

As explained earlier, the driving signal generation circuit 30 described herein functions as an example of a discharging pulse generating section according to an aspect of the invention. On the basis of the DAC data, the driving signal generation circuit 30 generates a driving signal COM that includes discharging pulses PS. As illustrated in FIG. 3, the driving signal generation circuit 30 includes a DAC circuit 31, a voltage amplification circuit 32, and a current amplification circuit 33. The DAC circuit 31 converts digital DAC data into an analog signal. The voltage amplification circuit 32 amplifies the level of the voltage of the analog signal, which has been generated by the DAC circuit 31 through the D/A conversion process, to a value that is large enough to drive the piezoelectric elements 433. In the configuration of the printer 1 according to the present embodiment of the invention, the level of an analog signal that is outputted from the voltage amplification circuit 32 after the amplification processing is 42V at the maximum whereas the level of an analog signal that is outputted from the DAC circuit 31 before the amplification processing is 3.3V at the maximum. The amplified analog signal that is outputted from the voltage amplification circuit 32 may be hereafter referred to as “waveform signal” for the purpose of simplifying its denotation. The current amplification circuit 33 amplifies the current level of the waveform signal that has been supplied from the voltage amplification circuit 32 and then outputs the current-amplified signal as a driving signal COM. The current amplification circuit 33 is made up of, for example, a pair of push-pull transistors.

### Head Control Unit HC

The head control unit HC selects a necessary part of the driving signal COM that was generated at the driving signal generation circuit 30 on the basis of a head control signal that has been supplied from the CPU 62 of the printer-side controller 60. In order to make such selection, as illustrated in FIG. 3, the head control unit HC is provided with a plurality of selection switches 44. The switch 44 is provided for each of the plurality of piezoelectric elements 433 en route on the feeder line of a driving signal COM thereto. The head control unit HC generates a switch control signal from the head control signal. Through the controlling of each switch 44 with the use of the switch control signal, the head control unit HC selectively applies a necessary part of the driving signal COM (e.g., discharging pulse PS) to the piezoelectric element 433. The discharging of ink from the nozzle 427 can be controlled depending on how the selection of the necessary part is made.

### Driving Signal COM

Next, an explanation is given below of a driving signal COM that is generated by the driving signal generation circuit 30. A driving signal COM, an example of which is illustrated in FIG. 4, includes a plurality of repetitive discharging pulses PS. These repetitions of discharging pulses PS have a uniform waveform. The pattern of a change in the electric potential level thereof is the same throughout the repetitions. As explained earlier, the driving signal COM is applied to the driving electrode 435 of the piezoelectric element 433. Upon the application of the driving signal COM to the driving electrode 435, a difference arises between the electric-potential level of the driving electrode 435 and the electric-potential level of the common electrode 434, the latter of which is set at a fixed value, in accordance with the electric potential change pattern. As a result, the piezoelectric element 433 expands/contracts in accordance with the electric potential change pattern, thereby causing a change in the capacity of the pressure generation chamber 424. A pressure changes occurs in ink that is retained in the pressure generation chamber 424 because of the change in the capacity of the pressure generation chamber 424. Accordingly, ink drops are discharged from the nozzle 427 due to the ink pressure change. The number of times of discharging operations per unit time, that is, discharging frequency, is determined on the basis of the interval of discharging timing segments in the sequential discharging of ink. For example, in the illustration of FIG. 4, ink-drop discharging is performed once during each pulse period of Ta for a driving signal COM that is indicated with a solid line, whereas ink-drop discharging is performed once during each pulse period of Tb for a driving signal COM that is indicated with an alternate long and short dash line. Therefore, it can be said that the discharging frequency of the former driving signal COM that is indicated with the solid line is higher than that of the latter driving signal COM that is indicated with the alternate long and short dash line.

### Discharging Pulse PS

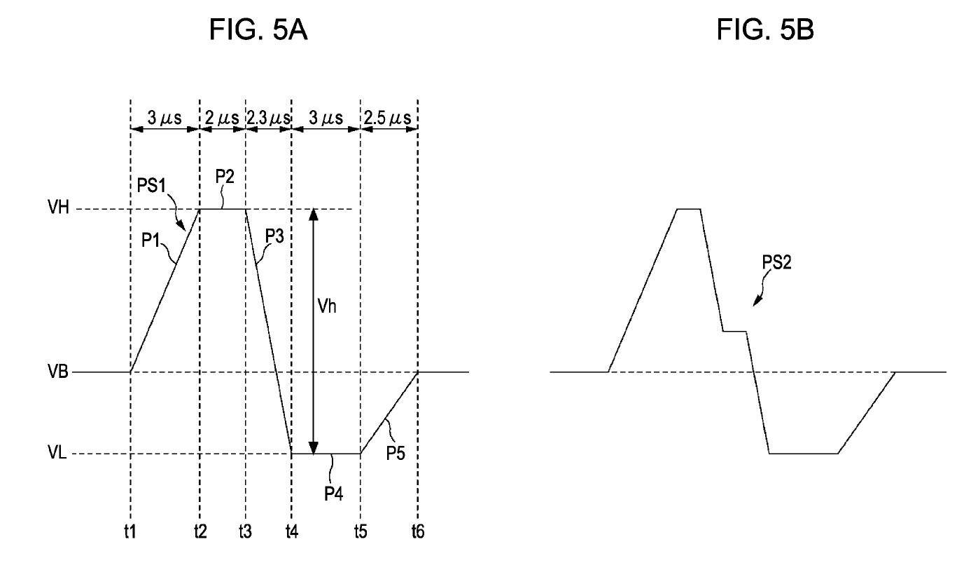

As explained earlier, the discharging pulse PS determines the behavior of the piezoelectric element 433. In other words, the discharging pulse PS predetermines the degree of the deformation of the piezoelectric element 433 in association with each point in time. Therefore, it is possible to vary the pattern of a pressure change that occurs in ink that is retained in the pressure generation chamber 424 by varying the pattern of the electric-potential level change of the discharging pulse PS. The discharging of ink drops is performed through the utilization of an ink pressure change. For this reason, it is possible to vary the amount of ink drops that are discharged from the head HD (nozzles 427) by arbitrarily setting the pattern of the electric-potential level change of the discharging pulse PS (which may be hereafter referred to as “waveform”). For example, if a discharging pulse PS1 that has a waveform illustrated in FIG. 5A is used, it is possible to discharge an ink drop whose amount is suitable for the formation of a large dot, whereas, if a discharging pulse PS2 that has a waveform illustrated in FIG. 5B is used, it is possible to discharge an ink drop whose amount is suitable for the formation of a small dot. The amount of an ink drop that is suitable for the formation of a small dot is smaller than the amount of an ink drop that is suitable for the formation of a large dot. For this reason, it is possible to cause the nozzle 427 to discharge an ink drop that varies in the amount thereof by selectively applying the discharging pulse PS1, PS2 to the piezoelectric element 433.

### Discharging Operation

### Overview

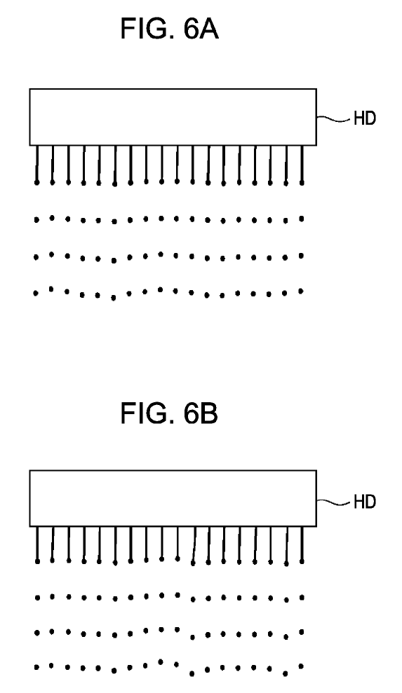

There is a demand for stable ink ejection performance with substantially smaller variation for some types of printers including the printer 1 described herein. For example, there is a need for making the amount of an ink drop, the direction of an ejection trajectory (i.e., ink-drop moving direction before landing onto an ejection target object) of the ink drop, the speed of ink-drop movement, and the like when ink drops are discharged in a low discharging frequency equal to the amount of an ink drop, the direction of an ejection trajectory of the ink drop, the speed of ink-drop movement, and the like when ink drops are discharged in a high discharging frequency. However, it has been difficult to stabilize the discharging of ink if ink that has viscosity that is significantly higher than that of ordinary ink (e.g., ordinary viscosity of approximately one millipascal second [approx. 1 mPa·s]) is discharged with the use of a head HD of the related art. For example, it has been difficult to stabilize the discharging of ink if ink that has viscosity of 8-20 mPa·s is discharged with the use of a head HD of the related art. In the description of this specification, such ink that has viscosity significantly higher than that of ordinary ink is referred to as “high viscosity ink” for the purpose of explanation. FIG. 6A is a diagram that schematically illustrates an example of a stable discharging state in which high viscosity ink is discharged with ink-drop discharging uniformity. FIG. 6B is a diagram that schematically illustrates an example of an unstable high-viscosity-ink discharging state, which shows the lack of ink-drop discharging uniformity. As will be understood from a comparison of FIGS. 6A and 6B, some ink drops have a low and thus insufficient discharge movement speed in an unstable discharging state. Other ink drops have an undesirable discharge movement trajectory/direction in an unstable discharging state. The stability in ink-discharging performance explained above is also required in a case where an ink drop that varies in the amount thereof depending on the discharging pulse is discharged.

With such a demand for stable ink ejection performance being taken into consideration, in the configuration of the head HD according to the present embodiment of the invention, the diameter φ427 of the nozzle 427 is determined at such a value that makes it possible to discharge plural types of ink drops that are different in amount from each other or one another. In addition, the length L427 (flow-channel length) of the nozzle 427 is determined on the basis of the length L425 (flow-channel length) of the ink supply passage 425 in order to efficiently utilize a pressure change that occurs in ink that is retained in the pressure generation chamber 424 for the discharging of an ink drop. Specifically, the diameter φ427 of the nozzle 427 is set within a range from 15 μ inclusive to 40 μ inclusive. Moreover, the length L427 of the nozzle 427 is set at a value that is smaller than the length L425 of the ink supply passage 425 multiplied by 0.2.

As illustrated in FIG. 2B, it is assumed that the nozzle 427 has a substantially uniform cross section taken along a plane orthogonal to the nozzle direction (i.e., section area Snzl). That is, it is assumed that the nozzle 427 has a shape that demarcates a columnar space. When the nozzle 427 has such a columnar shape, the opening diameter of the nozzle 427 corresponds to the diameter φ427. The length of the nozzle 427 measured from the discharging-side opening thereof to the pressure-chamber-side (424) inlet thereof corresponds to the length L427.

### Head HD

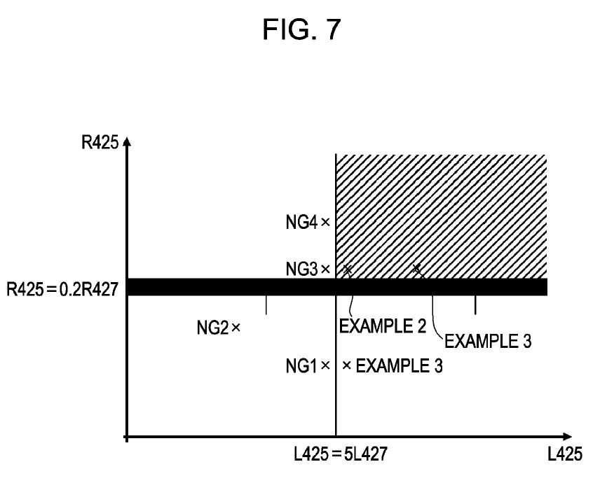

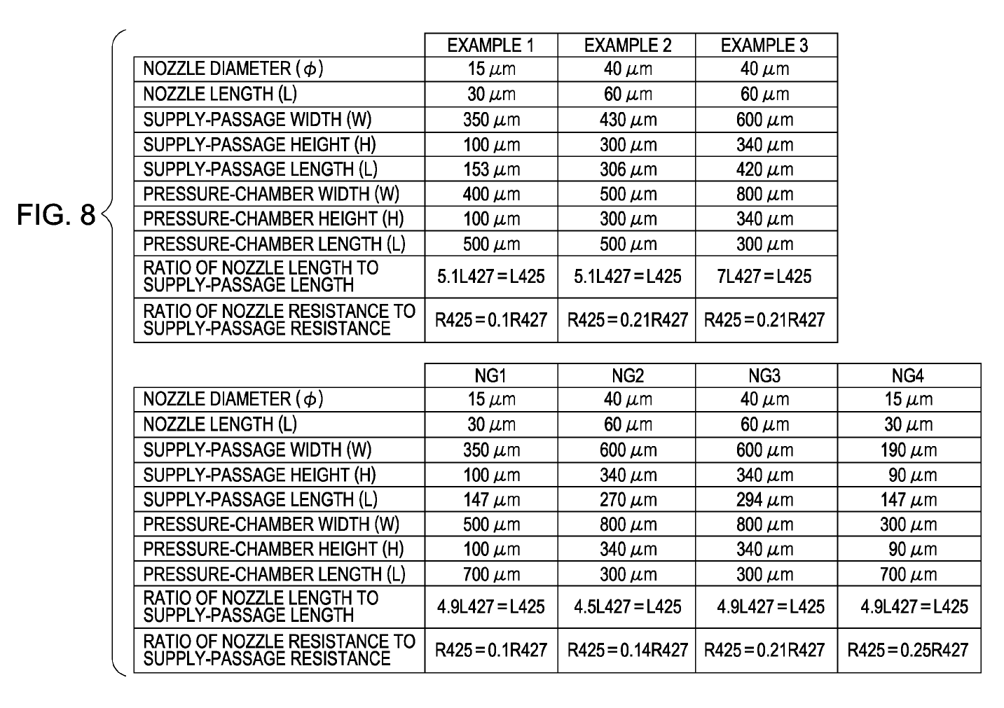

FIG. 7 is a diagram that shows the property of evaluation target heads HD according to the present embodiment of the invention and the property of evaluation target heads HD of comparative examples. FIG. 8 is a diagram that shows the dimension of evaluation target heads HD according to the present embodiment of the invention and the dimension of evaluation target heads HD of comparative examples. Among the illustrated evaluation target heads HD, heads according to the present embodiment of the invention are denoted as Example 1, Example 2, and Example 3. Heads denoted as NG1, NG2, NG3, and NG4 are related-art heads, which are shown as comparative examples.

As shown in FIG. 8, the diameter φ427 of the nozzle 427 of each head HD according to the present embodiment of the invention is set within a range from 15 μ inclusive to 40 μ inclusive. Specifically, as shown therein, the diameter φ427 of the nozzle 427 of the head HD according to the first example (Example 1) of the present embodiment of the invention is 15 μ. The diameter φ427 of the nozzle 427 of the head HD according to the second example of the present embodiment of the invention is 40 μ. The diameter φ427 of the nozzle 427 of the head HD according to the third example of the present embodiment of the invention is 40 μ. In addition, the length L427 of the nozzle 427 of each head HD according to the present embodiment of the invention is set at a value that is smaller than the length L425 of the ink supply passage 425 multiplied by 0.2. That is, as shown therein, the length L425 of the ink supply passage 425 of the head HD according to each of the first example of the present embodiment of the invention and the second example of the present embodiment of the invention is 5.1 times as great as the length L427 of the nozzle 427 thereof (which means that L427 is approximately equal to L425 multiplied by 0.196). The length L425 of the ink supply passage 425 of the head HD according to the third example of the present embodiment of the invention is seven times as great as the length L427 of the nozzle 427 thereof (which means that L427 is approximately equal to L425 multiplied by 0.143). Specifically, as shown therein, the length L425 of the ink supply passage 425 of the head HD according to the first example of the present embodiment of the invention is 153 μm, whereas the length L427 of the nozzle 427 thereof is 30 μ. The length L425 of the ink supply passage 425 of the head HD according to the second example of the present embodiment of the invention is 306 μm, whereas the length L427 of the nozzle 427 thereof is 60 μ. The length L425 of the ink supply passage 425 of the head HD according to the third example of the present embodiment of the invention is 420 μm, whereas the length L427 of the nozzle 427 thereof is 60 μ.

In addition, the ratio of the resistance R425 of the ink supply passage 425 to the resistance R427 of the nozzle 427 of the head HD according to the first example of the present embodiment of the invention is different from the ratio of the resistance R425 of the ink supply passage 425 to the resistance R427 of the nozzle 427 of the head HD according to each of the second example of the present embodiment of the invention and the third example of the present embodiment of the invention. That is, the resistance R425 of the ink-supply passage 425 of the head HD according to each of the second example of the present embodiment of the invention and the third example of the present embodiment of the invention is set at a value that is larger than the resistance R427 of the nozzle 427 thereof multiplied by 0.2. In contrast, the resistance R425 of the ink-supply passage 425 of the head HD according to the first example of the present embodiment of the invention is set at a value that is not larger than the resistance R427 of the nozzle 427 thereof multiplied by 0.2. Specifically, the resistance R425 of the ink-supply passage 425 of the head HD according to each of the second example of the present embodiment of the invention and the third example of the present embodiment of the invention is set at a value that is equal to the resistance R427 of the nozzle 427 thereof multiplied by 0.21. On the other hand, the resistance R425 of the ink-supply passage 425 of the head HD according to the first example of the present embodiment of the invention is set at a value that is equal to the resistance R427 of the nozzle 427 thereof multiplied by 0.1. Herein, the resistance (flow-channel resistance) R is the internal loss of a medium. The resistance R according to the present embodiment of the invention is a force that is applied to ink that flows through an ink-flow channel. The resistance R is a force that acts in the direction opposite to the ink-flowing direction.

As explained earlier while referring to FIG. 2B, the ink supply passage 425 can be regarded as a flow channel that has a rectangular cross section Ssup. Therefore, the flow-channel resistance of the ink supply passage 425 can be calculated on the basis of the viscosity of ink (liquid) as well as on the basis of the length L425, the width W425, and the height H425 of the ink supply passage 425. That is, the flow-channel resistance of a flow channel that has the shape of a substantially rectangular parallelepiped can be mathematically expressed by the following formula (2), where the flow-channel resistance is denoted as Rrp (R rectangular parallelepiped) in the formula (2).

Flow-channel Resistance Rrp=(12×Viscosity μ×Length L)/(Width W×Height H³) (2)

On the other hand, the nozzle 427 can be regarded as a flow channel that has a circular cross section Snzl. Therefore, the flow-channel resistance of the nozzle 427 can be calculated on the basis of the viscosity of ink as well as on the basis of the radius (diameter φ427/2) of the nozzle 427 and the length L427 thereof. That is, the flow-channel resistance of a flow channel that has the shape of a column can be approximately expressed by the following formula (3) where the flow-channel resistance is denoted as Rc (R column) in the formula (3).

Flow-channel Resistance Rc=(8×Viscosity μ×Length L)/(π×Radius r⁴) (3)

In each of the above formulae (2) and (3), μ denotes the viscosity of ink. The length of a flow channel is denoted as L therein. The width of the flow channel and the height thereof are denoted as W and H therein, respectively. The reference symbol r denotes the radius of the latter flow channel that has the circular cross section.

Next, the dimension of the heads HD of comparative examples is explained below. The diameter φ427 of the nozzle 427 of the head HD according to each of the comparative examples NG1 and NG4 is 15 μ. The diameter φ427 of the nozzle 427 of the head HD according to each of the comparative examples NG2 and NG3 is 40 μ. Therefore, it is correct to state that there is no difference between the diameter φ427 of the nozzle 427 of the evaluation target head HD according to the present embodiment of the invention and the diameter φ427 of the nozzle 427 of the evaluation target head HD according to the comparative examples. However, the length L427 of the nozzle 427 of each head HD according to the comparative examples is set at a value that is not smaller than the length L425 of the ink supply passage 425 multiplied by 0.2. That is, as shown therein, the length L425 of the ink supply passage 425 of the head HD according to each of the first comparative example NG1, the third comparative example NG3, and the fourth comparative example NG4 is 4.9 times as great as the length L427 of the nozzle 427 thereof (which means that L427 is approximately equal to L425 multiplied by 0.204). The length L425 of the ink supply passage 425 of the head HD according to the second comparative example NG2 is 4.5 times as great as the length L427 of the nozzle 427 thereof (which means that L427 is approximately equal to L425 multiplied by 0.222). Specifically, as shown therein, the length L425 of the ink supply passage 425 of the head HD according to each of the first comparative example NG1 and the fourth comparative example NG4 is 147 μm, whereas the length L427 of the nozzle 427 thereof is 30 μ. The length L425 of the ink supply passage 425 of the head HD according to the second comparative example NG2 is 270 μm, whereas the length L427 of the nozzle 427 thereof is 60 μ. The length L425 of the ink supply passage 425 of the head HD according to the third comparative example NG3 is 294 μm, whereas the length L427 of the nozzle 427 thereof is 60 μ.

In addition, in the structure of the evaluation target heads HD according to the comparative examples, the ratio of the resistance R425 of the ink supply passage 425 to the resistance R427 of the nozzle 427 differs from one head to another. Specifically, the resistance R425 of the ink-supply passage 425 of the head HD according to the first comparative example NG1 is set at a value that is equal to the resistance R427 of the nozzle 427 thereof multiplied by 0.1. The resistance R425 of the ink-supply passage 425 of the head HD according to the second comparative example NG2 is set at a value that is equal to the resistance R427 of the nozzle 427 thereof multiplied by 0.14. The resistance R425 of the ink-supply passage 425 of the head HD according to the third comparative example NG3 is set at a value that is equal to the resistance R427 of the nozzle 427 thereof multiplied by 0.21. The resistance R425 of the ink-supply passage 425 of the head HD according to the fourth comparative example NG4 is set at a value that is equal to the resistance R427 of the nozzle 427 thereof multiplied by 0.25.

### Discharging Pulse PS

A discharging pulse PS for evaluation can be selected among pulses having various pulse patterns, a few examples of which have been mentioned earlier with reference to FIGS. 5A and 5B. In our evaluation, the discharging pulse PS1 that is shown in FIG. 5A was used for discharging an ink drop whose amount is suitable for the formation of a large dot. The discharging pulse PS1 has a plurality of timing/level segments that is denoted as P1, P2, P3, P4, and P5 in each pulse period. That is, the discharging pulse PS1 includes a first depressurization segment P1, a first electric-potential level holding segment P2, a pressurization segment P3, a second electric-potential level holding segment P4, and a second depressurization segment P5.

The first depressurization segment P1 corresponds to a time period from timing (i.e., point in time) t1 through timing t2. The start electric potential level of the first depressurization segment P1 is an intermediate electric potential level VB. The end electric potential level of the first depressurization segment P1 is the maximum electric potential level VH. Therefore, when a voltage that corresponds to an electric potential change of the first depressurization segment P1 is applied to the piezoelectric element 433, the pressure generation chamber 424 expands so that its capacity increases from a reference capacity to the maximum capacity during the time period of the generation of the first depressurization part P1 of the pulse. The first depressurization segment P1 corresponds to the expansion of the pressure generation chamber 424 that is performed as preparatory operation before the discharging of an ink drop. The driving voltage Vh of the discharging pulse PS1, that is, a difference between the maximum electric potential level VH and the minimum electric potential level VL, is 30V. The intermediate electric potential level VB is set at a value that is higher than the minimum electric potential level VL by 10V. The duration of the generation and application of the first depressurization part P1 of the discharging pulse PS1 is 3 μs.

The first electric-potential level holding segment P2 corresponds to a time period from timing t2 through timing t3. The electric potential level of the first electric-potential level holding segment P2 is kept at the maximum electric potential level VH. Therefore, when the first electric-potential level holding part P2 of the pulse is applied to the piezoelectric element 433, the pressure generation chamber 424 maintains its maximum capacity. The maximum capacity of the pressure generation chamber 424 is kept during the time period of the generation of the first electric-potential level holding part P2 of the pulse. The duration of the generation and application of the first electric-potential level holding part P2 of the discharging pulse PS1 is 2 μs.

The pressurization segment P3 corresponds to a time period from timing t3 through timing t4. The start electric potential level of the pressurization segment P3 is the maximum electric potential level VH. The end electric potential level of the pressurization segment P3 is the minimum electric potential level VL. Therefore, when a voltage that corresponds to an electric potential change of the pressurization segment P3 is applied to the piezoelectric element 433, the pressure generation chamber 424 contracts so that its capacity decreases from the maximum capacity to the minimum capacity during the time period of the generation of the pressurization part P3 of the pulse. As the pressure generation chamber 424 contracts, ink that is retained therein is pressurized. As a result, the ink is ejected from the nozzle 427. Therefore, the pressurization segment P3 corresponds to a part of the pulse that causes the head HD to discharge an ink drop from the nozzle 427 thereof. The duration of the generation and application of the pressurization part P3 of the discharging pulse PS1 is 2.3 μs.

The second electric-potential level holding segment P4 corresponds to a time period from timing t4 through timing t5. The electric potential level of the second electric-potential level holding segment P4 is kept at the minimum electric potential level VL. Therefore, when the second electric-potential level holding part P4 of the pulse is applied to the piezoelectric element 433, the pressure generation chamber 424 maintains its minimum capacity. The minimum capacity of the pressure generation chamber 424 is kept during the time period of the generation of the second electric-potential level holding part P4 of the pulse. The duration of the generation and application of the second electric-potential level holding part P4 of the discharging pulse PS1 is 3 μs.

The second depressurization segment P5 corresponds to a time period from timing t5 through timing t6. The start electric potential level of the second depressurization segment P5 is the minimum electric potential level VH. The end electric potential level of the second depressurization segment P5 is the intermediate electric potential level VB. Therefore, when a voltage that corresponds to an electric potential change of the second depressurization segment P5 is applied to the piezoelectric element 433, the pressure generation chamber 424 expands so that its capacity increases from the minimum capacity to the reference capacity during the time period of the generation of the second depressurization part P5 of the pulse. The discharging pulse PS1 includes the second depressurization segment P5 so as to cause the piezoelectric element 433 to perform operation for the expansion of the pressure generation chamber 424 that is in a contracted state after the discharging of an ink drop back to the reference capacity. The duration of the generation and application of the second depressurization part P5 of the discharging pulse PS1 is 2.5 μs.

Various pulses can be used as a discharging pulse PS for the formation of a small dot. For example, the discharging pulse PS2 that is shown in FIG. 5B can be used as a discharging pulse PS for the formation of a small dot. Or, the discharging pulse PS1 that is shown in FIG. 5A may be modified and then used as a discharging pulse PS for the formation of a small dot. It is important to note that the discharging pulse PS for the formation of a small dot specifies the pattern of a pressure change in ink retained in the pressure generation chamber 424 that is different from the pattern of a pressure change in ink retained in the pressure generation chamber 424 specified by the discharging pulse PS for the formation of a large dot. It is possible to vary the behavior of meniscus (i.e., the free surface of ink exposed at the nozzle 427) by varying the pattern of a pressure change that occurs in ink that is retained in the pressure generation chamber 424. As a result, it is possible to make the amount of an ink drop that is discharged smaller in comparison with a case where a discharging pulse PS for the formation of a large dot is used.

### Evaluation Result

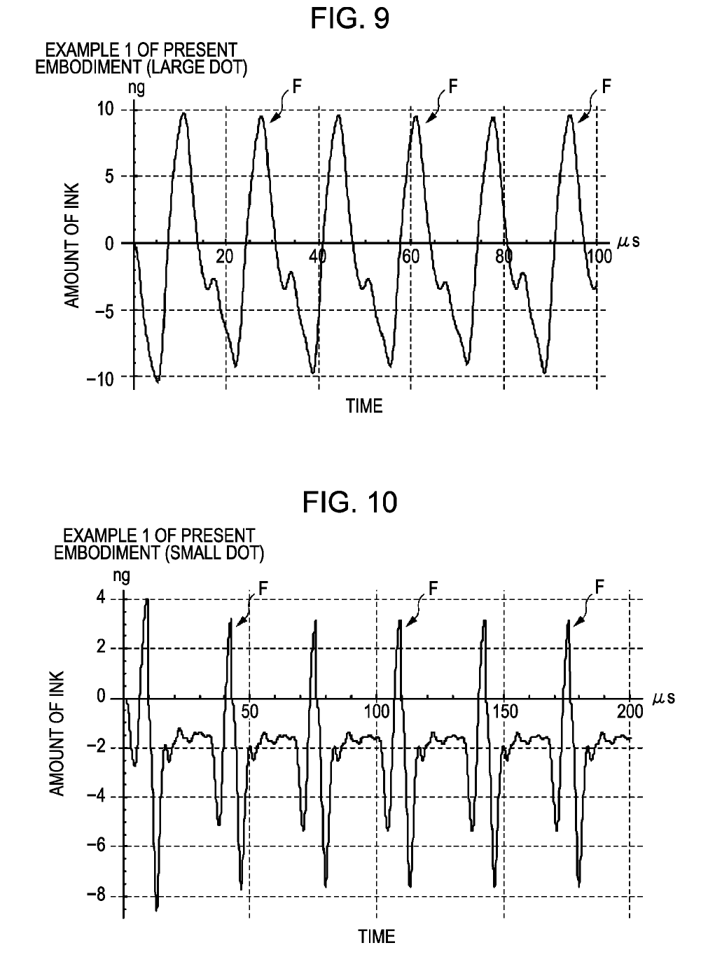

Each of FIGS. 9 to 13 shows a result of the discharging of ink drops that is performed with the use of an evaluation head HD according to the present embodiment of the invention. Each of FIGS. 14 to 17 shows a result of the discharging of ink drops that is performed with the use of an evaluation head HD according to the comparative example. The evaluation result illustrated in these drawings was obtained by simulation.

Each of FIGS. 9 and 10 is a diagram that schematically illustrates the discharging of ink drops that is performed by the head HD according to the first example of the present embodiment of the invention. Specifically, FIG. 9 is a diagram that schematically illustrates the discharging of ink drops for the formation of large dots that is performed at a discharging frequency of approximately 60 kHz with the use of ink that has viscosity of 20 mPa·s (whose relative density is approximately one) FIG. 10 is a diagram that schematically illustrates the discharging of ink drops for the formation of small dots that is performed at a discharging frequency of approximately 30 kHz with the use of ink that has the same viscosity as above.

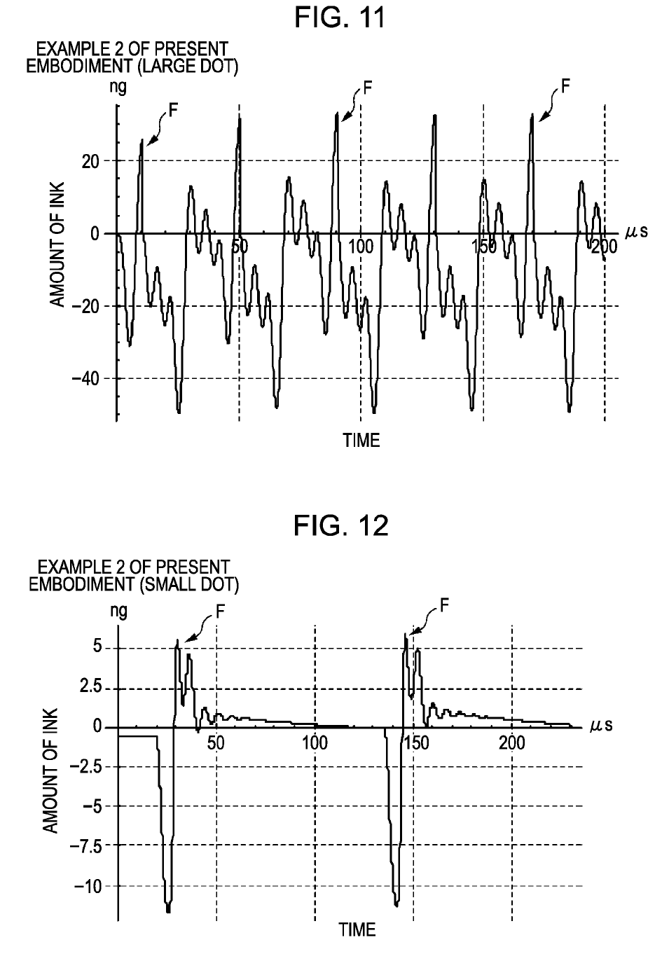

Each of FIGS. 11 and 12 is a diagram that schematically illustrates the discharging of ink drops that is performed by the head HD according to the second example of the present embodiment of the invention. Specifically, FIG. 11 is a diagram that schematically illustrates the discharging of ink drops for the formation of large dots that is performed at a discharging frequency of approximately 30 kHz with the use of ink that has viscosity of 20 mPa·s. FIG. 12 is a diagram that schematically illustrates the discharging of ink drops for the formation of small dots that is performed at a discharging frequency of approximately 10 kHz with the use of ink that has the same viscosity as above.

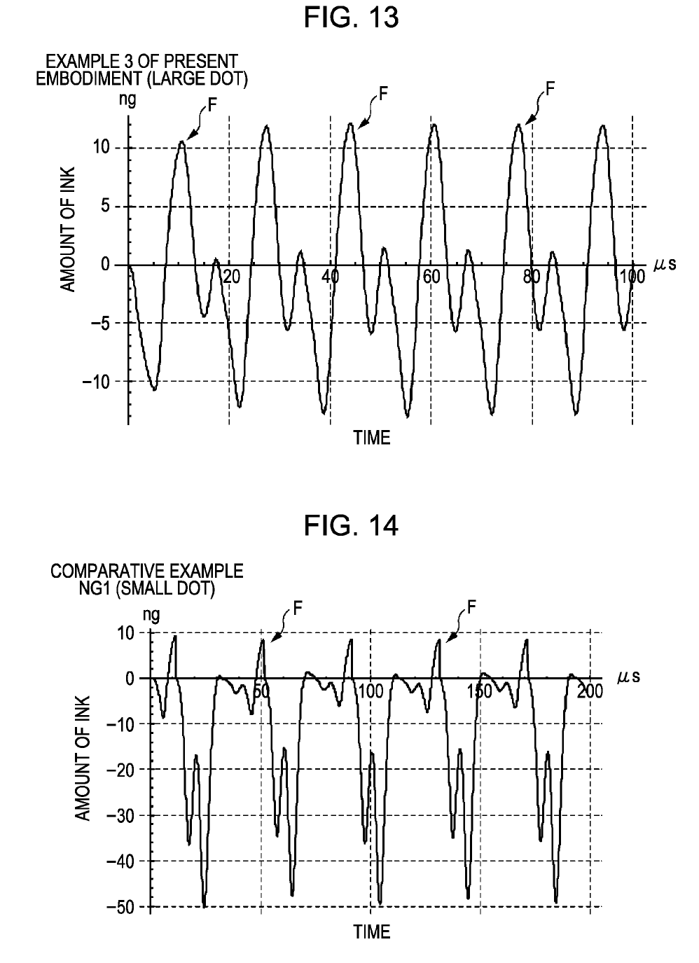

FIG. 13 is a diagram that schematically illustrates the discharging of ink drops that is performed by the head HD according to the third example of the present embodiment of the invention. Specifically, FIG. 13 is a diagram that schematically illustrates the discharging of ink drops for the formation of large dots that is performed at a discharging frequency of approximately 60 kHz with the use of ink that has viscosity of 8 mPa·s (whose relative density is approximately one).

In each of these drawings, the vertical axis represents the position (state) of meniscus, which is expressed by the amount of ink. The horizontal axis represents time. The value “0 ng” shown on the vertical axis indicates the position of meniscus in a stationary state. As a numeric value shown therein increases to the positive side, it shows that the meniscus is relatively pushed in the discharging direction. As the absolute value of a negative value increases, it shows that the meniscus is relatively pulled to the pressure-chamber (424) side. Each point in time that is indicated with the reference symbol F shows timing at which an ink drop is discharged. The amount of ink taken at the timing F corresponds to the amount of an ink drop that is discharged. Herein, it is considered that an ink drop is discharged from the nozzle 427 when the front-end part of meniscus that is pushed out like a pillar is broken off. Therefore, when an ink drop is discharged from the nozzle 427, meniscus moves rapidly toward the pressure generation chamber 424 by the reaction thereof.

As illustrated in FIGS. 9, 11, and 13, it was verified that the head HD according to the present embodiment of the invention is capable of discharging an ink drop whose amount is suitable for the formation of a large dot in a stable manner. Specifically, as illustrated in FIG. 9, it was verified that the head HD according to the first example of the present embodiment of the invention is capable of discharging ink drops of approximately 10 ng in a stable manner, that is, with substantially small variation in the amount of ink drops. As illustrated in FIG. 11, it was verified that the head HD according to the second example of the present embodiment of the invention is capable of discharging ink drops of approximately 22 ng in a stable manner. As illustrated in FIG. 13, it was verified that the head HD according to the third example of the present embodiment of the invention is capable of discharging ink drops of approximately 10 ng in a stable manner.

As illustrated in FIGS. 10 and 12, it was further verified that the head HD according to the present embodiment of the invention is capable of discharging an ink drop whose amount is suitable for the formation of a small dot in a stable manner. As illustrated in FIG. 10, it was verified that the head HD according to the first example of the present embodiment of the invention is capable of discharging ink drops of approximately 3 ng in a stable manner. As illustrated in FIG. 12, it was verified that the head HD according to the second example of the present embodiment of the invention is capable of discharging ink drops of approximately 5.5 ng in a stable manner. It is guessed with reasonable grounds that the head HD according to the third example of the present embodiment of the invention is also capable of discharging an ink drop whose amount is suitable for the formation of a small dot in a stable manner, considering that the head HD according to the third example of the present embodiment of the invention is capable of discharging an ink drop whose amount is suitable for the formation of a large dot in a stable manner and further considering that each of the head HD according to the first example of the present embodiment of the invention and the head HD according to the second example of the present embodiment of the invention is capable of discharging an ink drop whose amount is suitable for the formation of a small dot in a stable manner.

The evaluation criteria that are applied to the head HD according to the present embodiment of the invention is: the discharging amount of an ink drop is greater than or at least approximately equal to 10 ng when ink drops are discharged sequentially at a discharging frequency of 30 kHz; and in addition thereto, the ejection of ink is performed with substantially small variation in the amount of ink drops, that is, in a stable manner. The reason why the above criteria are adopted is that, on the condition that ink drops each of which is approximately equal to 10 ng or larger in amount are discharged in a stable manner, it is possible to perform the printing of an image even when high viscosity ink is used while achieving a printing speed that is not lower than that of a printer that discharges ordinary ink and further achieving image quality that is not lower than that of the printer that discharges ordinary ink.

We consider that one of the reasons why the head HD according to the present embodiment of the invention successfully discharged plural types of ink drops that differ in amount in a stable manner in our evaluation is that the diameter φ427 of the nozzle 427 is determined at such a value that is suitable for discharging an ink drop whose amount is approximately 10-20 ng. Another reason why the head HD according to the present embodiment of the invention successfully discharged plural types of ink drops that differ in amount in a stable manner in our evaluation is that the ratio of the length L427 of the nozzle 427 to the length L425 of the ink supply passage 425 is set at an appropriate value. Specifically, the length L427 of the nozzle 427 of each head HD according to the present embodiment of the invention is set at a value that is smaller than the length L425 of the ink supply passage 425 multiplied by 0.2. With such a structure, it is possible to efficiently utilize a pressure change that occurs in ink that is retained in the pressure generation chamber 424 for the discharging of an ink drop. In other words, it is possible to efficiently utilize a pressure change that occurs in ink that is retained in the pressure generation chamber 424 for meniscus motion. As in the configuration of each head HD according to the present embodiment of the invention, it is preferable that the length L427 of the nozzle 427 should be greater than or, at the shortest, equal to 30 μ. The reason why the nozzle 427 should not be shorter than 30 μ is to secure required rigidity. In addition, the length L427 of the nozzle 427 is equivalent to the thickness of the nozzle plate 422. Therefore, if the nozzle 427 is not shorter than 30 μm, it is possible to make the machining of the nozzle plate 422 easier. Moreover, it is possible to increase dimensional accuracy.

We consider that it is preferable to set the flow-channel resistance R425 of the ink-supply passage 425 at a value that is larger than the flow-channel resistance R427 of the nozzle 427 multiplied by 0.2. If the flow-channel resistance R425 of the ink-supply passage 425 is set at a value that is larger than the flow-channel resistance R427 of the nozzle 427 multiplied by 0.2, it is possible to attenuate the pressure oscillation of ink after the discharging of an ink drop at the ink-supply-passage (425) side. That is, it is possible to absorb or reduce the pressure oscillation of ink without losing the easiness in the motion of meniscus.

It is possible to regard the nozzle 427 as a pipe through which ink (medium) flows. The ink supply passage 425 can also be regarded as a pipe through which ink flows. When a pressure is applied to ink from the outside of a pipe through which the ink flows, it becomes easier for the ink to flow as the diameter of the pipe increases, whereas it becomes harder for the ink to flow as the mass of the ink increases. Since a flow channel and a medium have such a relationship, the degree of easiness in the flowing of ink through a pipe is herein expressed by borrowing the concept of inertance in an acoustic circuit. Let the density of ink be denoted as p. Let a cross section taken along a plane orthogonal to the direction of the flowing of ink through a flow channel be denoted as S. Let the length of the flow channel be denoted as L. Then, inertance M can be approximately expressed by the following formula (4). In the formula (4) shown below, as illustrated in FIG. 2B, the length L of the flow channel represents the length of each component of the modeled ink flow channel. The section area S thereof represents the section area of each component of the modeled ink flow channel. The length L is measured along the flowing direction of ink. The section area S is an area size of a plane that is substantially orthogonal to the flowing direction of ink.

Inertance M=(Density ρ×Length L)/Section Area S (4)

It is found from the formula (4) shown above that the inertance can be considered as the mass of ink per unit section area. As the inertance increases, it becomes harder for ink to move in accordance with the pressure of the ink inside the pressure generation chamber 424. As the inertance decreases, it becomes easier for ink to move in accordance with the pressure of the ink inside the pressure generation chamber 424. When high viscosity ink is ejected, it is preferable to set the inertance of the nozzle 427 at a value that is smaller than that of the ink supply passage 425. The reason why the inertance of the nozzle 427 should be set at a value that is smaller than that of the ink supply passage 425 for the ejection of high viscosity ink is to make it possible to cause the motion of meniscus efficiently on the basis of the vibration of a pressure applied to the ink inside the pressure generation chamber 424.

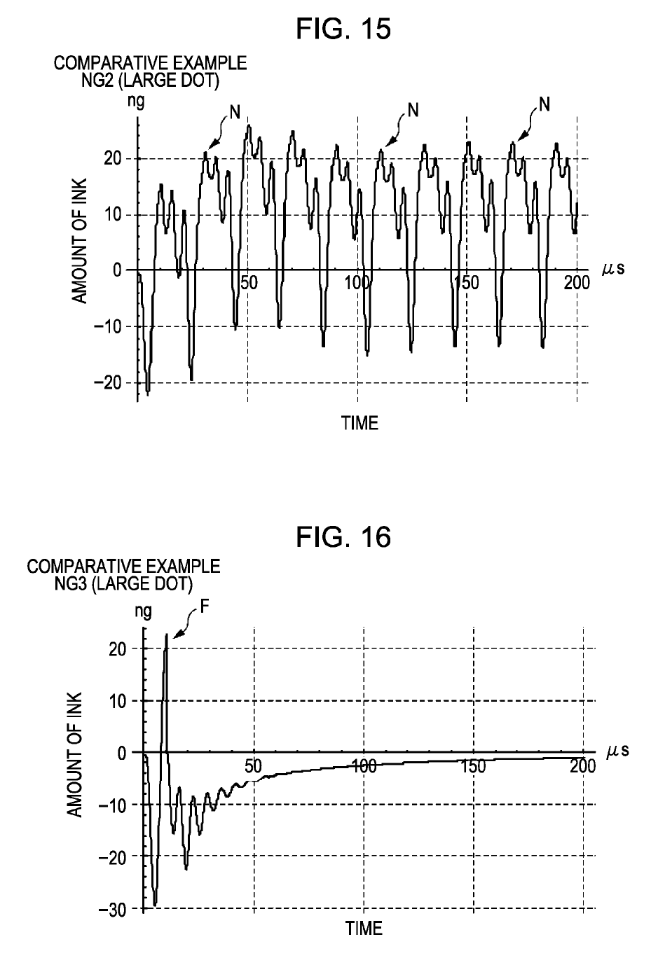

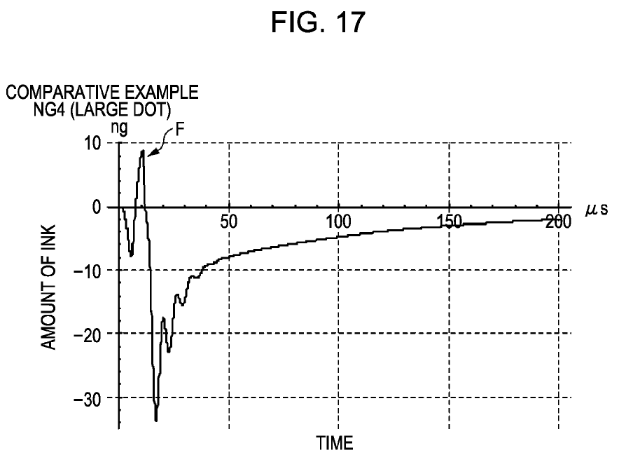

In contrast, as illustrated in FIGS. 14-17, we consider that heads HD according to the comparative examples have a difficulty in the discharging of ink drops, which is less stable in comparison with the ink-discharging operation of heads HD according to the present embodiment of the invention. For example, as will be understood from FIG. 14, the head HD according to the first comparative example NG1 has a difficulty in the discharging of ink drops in that meniscus is drawn excessively at the time of the discharging thereof for the formation of small dots. When meniscus is drawn excessively, there is a possibility that the meniscus goes into the pressure generation chamber 424 in the form of bubbles. As will be understood from FIG. 15, the head HD according to the second comparative example NG2 seemingly fails to discharge ink drops. That is, it is understood from the drawing that the amount of the returning motion of meniscus toward the pressure generation chamber 424 is small after each ink-drop discharging timing, which is denoted as N therein. As will be understood from FIGS. 16 and 17, the head HD according to each of the third comparative example NG3 and the fourth comparative example NG4 has a difficulty in the discharging of ink drops in that meniscus has not yet returned to a stationary state even after the lapse of 200 μs since the start of the application of a discharging pulse PS. This is seemingly because the amount of ink that is supplied to the pressure generation chamber 424 through the ink supply passage 425 is not sufficient. For this reason, it seems to be difficult to obtain a desired discharge movement trajectory such as straight one when ink drops are discharged sequentially from the head HD according to each of the third comparative example NG3 and the fourth comparative example NG4.

### Other Exemplary Embodiments of the Invention

Although a printing system that includes the printer 1 as an example of a liquid discharging apparatus according to an aspect of the invention is mainly described in the foregoing exemplary embodiment of the invention, the foregoing description further discloses a liquid discharging method according to an aspect of the invention, a liquid discharging system according to an aspect of the invention, a method for setting discharging pulses (PS) according to an aspect of the invention, without any limitation thereto. Although the present invention is explained above with the disclosure of an exemplary embodiment thereof, the specific embodiment described above is provided solely for the purpose of facilitating the understanding of the invention. The above explanatory embodiment should in no case be interpreted to limit the scope of the invention. The invention may be modified, altered, changed, adapted, and/or improved within a range not departing from the gist and/or spirit of the invention apprehended by a person skilled in the art from explicit and implicit description made herein, where such a modification, an alteration, a change, an adaptation, and/or an improvement is also covered by the scope of the appended claims. It is the intention of the inventor/applicant that the scope of the invention covers any equivalents thereof without departing therefrom. In particular, it is intended that the following specific variation of the embodiment should also fall within the scope of the invention.

### Modified Head HD

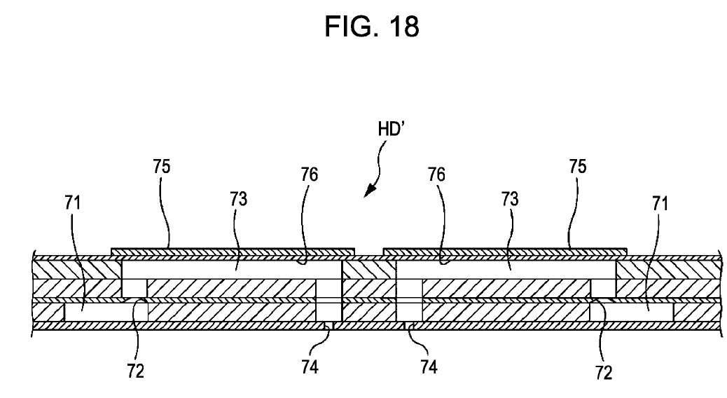

The head HD according to the foregoing exemplary embodiment of the invention is provided with a certain type of piezoelectric elements each of which becomes deformed so as to increase the capacity of the corresponding pressure generation chamber 424 as the level of an electric potential that is specified by a discharging pulse PS goes up. Notwithstanding the foregoing, however, an alternative type of piezoelectric elements may be used. The head HD′ illustrated in FIG. 18 as a modification example is provided with an alternative type of piezoelectric elements each of which becomes deformed so as to decrease the capacity of the corresponding pressure generation chamber 73 as the level of an electric potential that is specified by a discharging pulse PS goes up.

The configuration of the modified head HD′ is briefly explained below. The modified head HD′ is provided with a common ink chamber 71, a plurality of ink supply ports 72, a plurality of pressure generation chambers 73, and a plurality of nozzles 74. Ink flow channels whose number is the same as the number of the nozzles 74 are formed in the modified head HD′. Each of the plurality of the ink flow channels is formed as a passage through which ink flows from the common ink chamber 71 to the corresponding nozzle 74 through the corresponding ink supply port 72 and the corresponding pressure generation chamber 73. As in the configuration of the head HD according to the foregoing exemplary embodiment of the invention, the capacity of each pressure generation chamber 73 changes as a result of the operation of the corresponding piezoelectric element 75 in the configuration of the modified head HD′ described herein. That is, a part of a vibration plate 76 constitutes, for example, a part of the chamber wall of the pressure generation chamber 73. The piezoelectric element 75 is provided on one surface of the vibration plate 76 that is opposite to the other surface thereof that demarcates a part of the pressure generation chamber 73.

Each of a plurality of piezoelectric elements 75 is provided for the corresponding one of the plurality of pressure generation chambers 73. Each piezoelectric element 75 includes, for example, an upper electrode, a lower electrode, and a piezoelectric substance that is sandwiched between the upper electrode and the lower electrode, none of which is illustrated in the drawing. The piezoelectric element 75 becomes deformed when there is a difference between the level of the electric potential of the upper electrode and the level of the electric potential of the lower electrode. In this modification example, the piezoelectric substance becomes charged as the level of the electric potential of the upper electrode goes up. As the piezoelectric substance becomes charged, the piezoelectric element 75 becomes deflected so as to form a convex that is oriented toward the pressure generation chamber 73. As a result, the pressure generation chamber 73 contracts so as to decrease the capacity thereof. In the configuration of the modified head HD′, a part of the vibration plate 76 that demarcates a part of the pressure generation chamber 73 constitutes an example of a demarcating section according to an aspect of the invention.

### Elements Activating Discharging Operation

The printer 1 according to the foregoing exemplary embodiment of the invention and the modification example explained above is provided with the piezoelectric elements 433, 75, which function as elements that activate the ejection of ink. However, an element that activates the ejection of ink is not limited to the piezoelectric element 433, 75 explained above. As a non-limiting modification example thereof, a heater element may be used in place of the piezoelectric element 433, 75. As another modification example thereof, a magnetostrictive element may be used in place of the piezoelectric element 433, 75. If the piezoelectric element 433, 75 is used as an element that activates the ejection of ink as described in the foregoing exemplary embodiment of the invention and the modification example, it is possible to control the capacity of the pressure generation chamber 424, 73 with high precision on the basis of the electric-potential level of a discharging pulse PS.

### Shapes of Nozzle 427, Ink Supply Passage 425, and Pressure Generation Chamber 424

In the foregoing description of an exemplary embodiment of the invention, it is explained that the nozzle 427 is formed as a through hole that demarcates a space of a circular cylinder. In other words, the nozzle 427 is formed as a through hole that has a circular opening shape and goes through the nozzle plate 422 when viewed in the direction of the thickness thereof. On the other hand, in the foregoing description of an exemplary embodiment of the invention, it is explained that the ink supply passage 425 is formed as a cavity that has a rectangular sectional shape. It is further explained therein that the ink supply passage 425 is formed between the pressure generation chamber 424 and the common ink chamber 426 so as to make the common ink chamber 426 in communication with the pressure generation chamber 424. In other words, the ink supply passage 425 is formed as a communication hole that demarcates a space of a rectangular column.

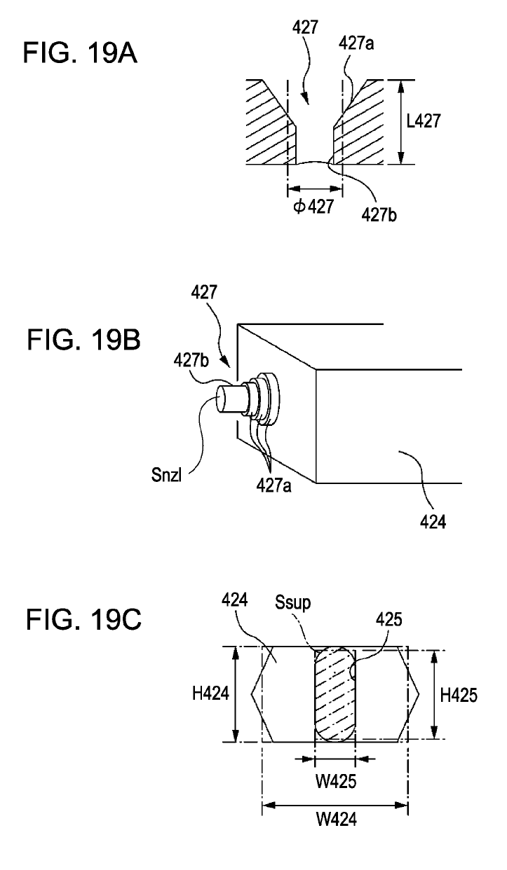

Notwithstanding the foregoing, however, the shape of the nozzle 427 can be modified into various shapes. The same holds true for the ink supply passage 425. For example, as illustrated in FIG. 19A, the nozzle 427 may be configured as a through hole that has a shape that resembles a funnel. The modified nozzle 427 that is illustrated in FIG. 19A has a tapered part 427a and a straight part 427b. The tapered part 427a of the modified nozzle 427 demarcates a space of a circular truncated cone. The opening area of the tapered part 427a of the modified nozzle 427 decreases as measured relatively away from the pressure generation chamber 424. That is, the truncated end of the tapered part 427a of the modified nozzle 427 has a smaller opening area than that of the opposite pressure-generation-chamber-side end thereof, which gradually decreases from the opposite pressure-generation-chamber-side end to the truncated end. The straight part 427b of the modified nozzle 427 extends from the truncated end of the tapered part 427a thereof. The straight part 427b demarcates a space of a circular cylinder. The straight part 427b constitutes a part of the modified nozzle 427 that is substantially uniform in cross section taken along a plane orthogonal to the nozzle direction (i.e., section area).

The modified nozzle 427 can be analyzed if the tapered part 427a thereof is defined as a part that demarcates a space made up of a plurality of circular plates whose diameters decrement in a stepped manner. Or, as illustrated in FIG. 19A, analysis can be performed if a nozzle that is substantially uniform in cross section taken along a plane orthogonal to the nozzle direction so as to be equivalent to the funnel-shaped nozzle is defined.

In like manner, as illustrated in FIG. 19C, for example, the ink supply passage 425 may be configured as a flow channel that has an opening shape of a “racetrack” circle that is elongated in a vertical direction. Herein, the term racetrack circle refers to a shape that includes two equi-radial semicircles that are connected with each other by external common tangents. The open area (i.e., cross section) Ssup of the modified ink supply passage 425 corresponds to the hatched elongated circle (i.e., racetrack area) that is shown in the drawing. The modified ink supply passage 425 having such a racetrack opening can be analyzed by defining a flow channel that has an equivalent rectangular opening. In such a case, the maximum height of the actual ink supply passage 425 is slightly greater than the height H425 of the ink supply passage 425 defined for analysis. Analysis can be performed in the same manner as above even in a case where the opening shape of the ink supply passage 425 is an ellipse or oval.

The shape of the pressure generation chamber 424 can also be modified into various shapes. Analysis can be performed in the same manner as above. For example, as illustrated in FIG. 19C, if a plane that is orthogonal to the direction of the length of the pressure generation chamber 424 has the shape of a horizontally long hexagon, it is possible to perform the analysis thereof by defining a flow channel that has an equivalent rectangular cross section. Specifically, it is possible to perform the analysis thereof by defining a flow channel that has a rectangular cross section whose height is H424 and whose width is W424, which is slightly smaller than the maximum width of the pressure generation chamber 424.

### OTHER APPLICATION EXAMPLES

In the foregoing description of an exemplary embodiment of the invention, the printer 1 is taken as an example of a liquid discharging apparatus according to an aspect of the invention. However, the scope of the invention is not limited to such a specific example. For example, a technique that is the same as or similar to the liquid ejection technique (e.g., ink-drop discharging technique) disclosed in the foregoing exemplary embodiment of the invention may be applied to various kinds of liquid discharging apparatuses that include, without any limitation thereto, a color filter manufacturing apparatus, a dyeing apparatus, a micro-fabrication/micro-machining apparatus, a semiconductor manufacturing apparatus, a surface treatment apparatus, a three-dimensional (3D) modeling apparatus, a liquid gasification apparatus, an organic electroluminescence (EL) manufacturing apparatus (in particular, a polymer EL manufacturing apparatus), a display manufacturing apparatus, a film deposition apparatus, and a DNA chip manufacturing apparatus. In addition to a variety of apparatuses enumerated above as non-limiting examples, the scope of the present invention encompasses methods and manufacturing methods corresponding to these apparatuses.

The entire disclosure of Japanese Patent Application No: 2008-082180, filed Mar. 26, 2008 and No: 2008-305335, filed Nov. 28, 2008 are expressly incorporated by reference herein.

What is claimed is:

1. A liquid discharging method comprising:
applying pressure to liquid that is to be discharged; and
discharging the liquid from a liquid discharging head,
wherein the viscosity of the liquid is within a range from 8 millipascal second inclusive to 20 millipascal second inclusive,
wherein the liquid discharging head includes
a nozzle from which the liquid is discharged,
a pressure chamber that causes a pressure change in the liquid so as to discharge the liquid from the nozzle, and
a liquid supplying section that is in communication with the pressure chamber and supplies the liquid to the pressure chamber,
wherein the pattern of the pressure change that occurs in the liquid is varied so as to selectively switch or control the amount of the liquid that is discharged from the nozzle at least between a predetermined amount and another amount that is smaller than the predetermined amount;
wherein the diameter of the nozzle is set within a range from 15 μ inclusive to 40 μm inclusive; and
the flow-channel length of the nozzle is set at a value that is smaller than the flow-channel length of the liquid supplying section multiplied by 0.2.

2. The liquid discharging method according to claim 1, wherein the flow-channel length of the nozzle is greater than or, at the shortest, equal to 30 μ.

3. The liquid discharging method according to claim 2, wherein the flow-channel length of the liquid supplying section is set within a range from 153 μ inclusive to 420 μm inclusive.

4. The liquid discharging method according to claim 1, wherein the flow-channel resistance of the liquid supplying section is set at a value that is larger than the flow-channel resistance of the nozzle multiplied by 0.2.

5. The liquid discharging method according to claim 1, wherein the inertance of the nozzle is set at a value that is smaller than that of the liquid supplying section.

6. The liquid discharging method according to claim 1, wherein the pressure chamber includes a demarcating section that demarcates a part of the pressure chamber and, when deformed, causes a pressure change in the liquid.

7. The liquid discharging method according to claim 6, wherein the liquid discharging head further includes an element that causes the demarcating section to be deformed by a variable degree that depends on the pattern of a change in the potential of the discharging pulse that is applied to the element.

8. A liquid discharging head comprising:
a nozzle from which liquid is discharged;
a pressure chamber that causes a pressure change in the liquid so as to discharge the liquid from the nozzle; and
a liquid supplying section that is in communication with the pressure chamber and supplies the liquid to the pressure chamber,
wherein the pattern of the pressure change that occurs in the liquid is varied so as to selectively switch or control the amount of the liquid that is discharged from the nozzle at least between a predetermined amount and another amount that is smaller than the predetermined amount;
the diameter of the nozzle is set within a range from 15 μ inclusive to 40 μ inclusive; and
the flow-channel length of the nozzle is set at a value that is smaller than the flow-channel length of the liquid supplying section multiplied by 0.2.

9. A liquid discharging apparatus comprising:
a discharging pulse generating section that generates a discharging pulse; and
a liquid discharging head that discharges liquid from a nozzle, the liquid discharging head including
a pressure chamber that causes a pressure change in the liquid by utilizing the deformation of a demarcating section so as to discharge the liquid from the nozzle, the pressure chamber varying the pattern of the pressure change that occurs in the liquid so as to selectively switch or control the amount of the liquid that is discharged from the nozzle at least between a predetermined amount and another amount that is smaller than the predetermined amount,
an element that causes the demarcating section to be deformed by a variable degree that depends on the pattern of a change in the potential of the discharging pulse that is applied to the element, and
a liquid supplying section that is in communication with the pressure chamber and supplies the liquid to the pressure chamber,
wherein the diameter of the nozzle is set within a range from 15 μ inclusive to 40 μm inclusive; and
the flow-channel length of the nozzle is set at a value that is smaller than the flow-channel length of the liquid supplying section multiplied by 0.2.
